(19) United States
(12) Patent Application Publication
(10) Pub. No.: US 2025/0013489 A1
(43) Pub. Date: Jan. 9, 2025

(54) Hardware accelerated activation of a processing unit

(71) Applicant: MELLANOX TECHNOLOGIES, LTD., Yokneam (IL)

(72) Inventors: Omri Kahalon, Tel Aviv (IL); Avi Urman, Yokneam (IL); Omer Cohen, Yokneam Illit (IL); Ilan Pardo, Ramat HaSharon (IL)

(21) Appl. No.: 18/347,643

(22) Filed: Jul. 6, 2023

(51) Int. Cl. G06F 9/48

(52) U.S. Cl. CPC G06F 9/4812; G06F 2009/45595

(57) ABSTRACT

In one embodiment, a network device includes a network interface to receive first packets from a network and send second packets over the network, and packet processing hardware to process a packet, accelerate activation of a given software program by performing at least one activation task of the given software program in hardware, and generate an interrupt to request a processing unit to execute the given software program to perform processing associated with the packet, and the processing unit to execute the given software program and perform processing associated with the packet, responsively to the at least one activation task performed by the packet processing hardware.

### FIELD OF THE INVENTION

The present invention relates to computer systems, and in particular, but not exclusively, to hardware accelerated activation of a processing unit.

### BACKGROUND

A network interface controller (NIC) (referred to in certain networks as a host bus adapter (HBA) or host channel adapter (HCA)) is a unit which manages the communications between a computer (e.g., a server) and a network, such as a local area network or switch fabric. The NIC directs packets from the network to their destination in the computer, for example by placing the packets in a buffer of a destination application in a memory unit of the computer and directs outgoing packets, for example sending them either to the network or to a loopback port. The directing of packets to their destination is generally referred to as packet steering, which includes determining a required destination of the packet and forwarding the packet to its destination. The NIC may implement a hash function using 5-tuple header information as input to a steering table to reach a forwarding decision. The action indicated by the steering table may direct the steering to another steering table, and so on. The actions may include forwarding, dropping, amending a header, encapsulation, decapsulation, rewrite, smooth, switch, or sort, for example.

US Patent Application 2017/0286292 of Levy, et al., describes a network element having a decision apparatus, which has a plurality of multi-way hash tables of single size and double size associative entries. A logic pipeline extracts a search key from each of a sequence of received data items. A hash circuit applies first and second hash functions to the search key to generate first and second indices. A lookup circuit reads associative entries in the hash tables that are indicated respectively by the first and second indices, and matches the search key against the associative entries in all the ways. Upon finding a match between the search key and an entry key in an indicated associative entry. A processor uses the value of the indicated associative entry to insert associative entries from a stash of associative entries into the hash tables in accordance with a single size and a double size cuckoo insertion procedure.

U.S. Pat. No. 10,015,090 to Arad, et al., describes a method for steering packets including receiving a packet and determining parameters to be used in steering the packet to a specific destination, in one or more initial steering stages, based on one or more packet specific attributes. The method further includes determining an identity of the specific destination of the packet in one or more subsequent steering stages, governed by the parameters determined in the one or more initial stages and one or more packet specific attributes, and forwarding the packet to the determined specific destination.

U.S. Pat. No. 10,015,090 describes packet steering by a network interface controller (NIC). The steering optionally includes determining for packets, based on their headers, a destination to which they are forwarded. The destination may be identified, for example, by a virtual unit identity, such as a virtual HCA-ID, and by a flow interface, e.g., an InfiniBand queue pair (QP) or an Ethernet receive ring. In some embodiments, the packet steering unit performs a multi-stage steering process in determining a single destination of the packet. The multi-stage steering process includes a plurality of stages in which a table lookup is performed based on packet specific information, e.g., address information in the packet. The packet specific information may include information in the packet and/or information on the packet not included in the packet, such as the port through which the packet was received. It is noted that the multi-stage steering process may forward the packet to additional destinations, in addition to the single destination. Furthermore, a single stage may be used to steer the packet to a plurality of the additional destinations.

### SUMMARY

There is provided in accordance with an embodiment of the present disclosure, a network device, including a network interface to receive first packets from a network and send second packets over the network, and packet processing hardware to process a packet, accelerate activation of a given software program by performing at least one activation task of the given software program in hardware, and generate an interrupt to request a processing unit to execute the given software program to perform processing associated with the packet, and the processing unit to execute the given software program and perform processing associated with the packet, responsively to the at least one activation task performed by the packet processing hardware.

Further in accordance with an embodiment of the present disclosure the given software program has a predetermined runtime, the processing unit is to execute the given software program until completion of the given software program and return control of processing the packet to the packet processing hardware, and the packet processing hardware is to continue processing the packet responsively to the completion of the execution of the given software program.

Still further in accordance with an embodiment of the present disclosure the packet processing hardware is to match data associated with the packet to an action responsively to at least one match-and-action table, and the action indicates details about execution of the given software program.

Additionally in accordance with an embodiment of the present disclosure the details about the given software program include any one or more of the following a program identifier of the given software program, control parameters for use in executing the given software program, address space information for use in executing the given software program, and a stack identifier of a stack region for use in executing the given software program.

Moreover, in accordance with an embodiment of the present disclosure the address space information indicates a global virtual machine identifier (GVMI) region of the given software program.

Further in accordance with an embodiment of the present disclosure GVMI region is shared by multiple software programs and the GVMI region is sub-divided among the software programs.

Still further in accordance with an embodiment of the present disclosure, the packet processing hardware includes activation context builder hardware to translate data in the action to data readable by the processing unit.

Additionally in accordance with an embodiment of the present disclosure the packet processing hardware includes memory setup hardware to configure a translation lookaside buffer (TLB) based on address space information indicated in the action.

Moreover, in accordance with an embodiment of the present disclosure the packet processing hardware includes memory setup hardware to configure memory access permissions based on control parameters and address space information indicated in the action.

Further in accordance with an embodiment of the present disclosure the packet processing hardware includes scheduler hardware to track use of the processing unit including finding a free hardware thread of the processing unit, maintain a list of pending software program execution requests, provide activation data for the given software program to the processing unit, and generate the interrupt to request the processing unit to execute the given software program on the free hardware thread based on activation data provided by the scheduler hardware to the processing unit.

Still further in accordance with an embodiment of the present disclosure the activation data includes any one or more of the following a program identifier of the given software program, a stack identifier of a stack region for use in executing the given software program, address space information for use in executing the given software program, control parameters for use in executing the given software program, and a pointer to data of at least part of the packet being processed by the packet processing hardware.

Additionally in accordance with an embodiment of the present disclosure the processing unit includes multiple processing cores, and the scheduler hardware is to track use of the processing cores, and generate the interrupt to a given one of the processing cores having the free hardware thread.

Moreover, in accordance with an embodiment of the present disclosure the packet processing hardware includes memory setup hardware to configure a translation lookaside buffer (TLB) based on address space information of the given software program.

Further in accordance with an embodiment of the present disclosure the packet processing hardware includes memory setup hardware to configure memory access permissions based on control parameters and address space information of the given software program.

Still further in accordance with an embodiment of the present disclosure the packet processing hardware includes scheduler hardware to track use of the processing unit including finding a free hardware thread of the processing unit, maintain a list of pending software program execution requests, provide activation data for the given software program to the processing unit, and generate the interrupt to request the processing unit to execute the given software program on the free hardware thread based on activation data provided by the scheduler hardware to the processing unit.

Additionally in accordance with an embodiment of the present disclosure the activation data includes any one or more of the following a program identifier of the given software program, a stack identifier of a stack region for use in executing the given software program, address space information for use in executing the given software program, control parameters for use in executing the given software program, and a pointer to data of at least part of the packet being processed by the packet processing hardware.

Moreover, in accordance with an embodiment of the present disclosure the processing unit includes multiple processing cores, and the scheduler hardware is to track use of the processing cores, and generate the interrupt to a given one of the processing cores having the free hardware thread.

Further in accordance with an embodiment of the present disclosure the packet processing hardware is to invoke the processing unit successively multiple times for the packet to execute at least one software program to perform processing associated with the packet, and the processing unit is to successively execute the at least one software program and perform processing associated with the packet.

Still further in accordance with an embodiment of the present disclosure processing unit is to execute a kernel on which to execute the given software program.

Additionally, in accordance with an embodiment of the present disclosure processing unit is to execute the given software program without an underlying kernel.

There is also provided in accordance with another embodiment of the present disclosure, a networking method, including receiving first packets from a network and sending second packets over the network, processing a packet, accelerating activation of a given software program by performing at least one activation task of the given software program in hardware, and generating an interrupt to request a processing unit to execute the given software program to perform processing associated with the packet, and executing the given software program and perform processing associated with the packet, responsively to the at least one activation task.

### BRIEF DESCRIPTION OF THE DRAWINGS

The present invention will be understood from the following detailed description, taken in conjunction with the drawings in which:

FIG. 1 is a block diagram view of a network device constructed and operative in accordance with an embodiment of the present invention;

FIG. 2 is a flowchart including steps in a method of processing a packet in the network device of FIG. 1;

FIG. 3 is a block diagram showing hardware activation of a software program in the network device of FIG. 1; and

FIG. 4 is a flowchart including steps in a method of operation of scheduler hardware in the network device of FIG. 1.

### DESCRIPTION OF EXAMPLE EMBODIMENTS

### Overview

As previously mentioned, a network device such as a NIC performs packet steering typically as part of packet processing. The steering process may be performed in hardware, for example, in an application-specific integrated circuit (ASIC). Such processing may be inflexible as the steering functionality is typically fixed to a large degree when the ASIC is manufactured. Therefore, if new steering functionality is needed after the ASIC is manufactured, the options may be to replace the ASIC, or forgo the new steering functionality.

One solution is to design an ASIC or packet processing engine which is integrated with a processing unit (e.g., a central processing unit comprising processing cores such as RISC-V) which runs software. The ASIC has built-in functionality to be able to request an external software program to be executed on the processor unit from the steering function within the ASIC so that if new steering functionality is needed, it may be implemented in software, which is run on the processing unit.

However, there is a latency problem inherent in processing by software, and is proportional to the amount of computation to be performed. The latency caused by the activation procedure of the software is the overhead, which is application independent and desirably should be minimal. Prior to the processing unit performing any software processing per packet (for a relevant network flow), the processing unit may need to wake up user space code from an interrupt, and the wake up includes a lot of processing. For example, the processing unit may need to receive an interrupt, understand from interrupt the context (e.g., the Virtual Machine (VM) global context of the VMs running on the host, the states, and flows) that the interrupt will be run in, need to prepare virtual memory address mappings, set up protection, isolation, and jump to the right program counter in the user space code. All the above adds latency. It should be noted that the processing unit may be called for some network flows and not called for others depending upon whether a network flow uses functionality provided by the processing unit.

In some environments, the wake up of the processing unit needs to take into account the context of the network flow of the packet being processed, such as a VM global context identified by a Global VM identifier (GVMI) which indicates all the resources which a flow has access to. A GVMI could include multiple flows. Each GVMI has a memory region in interconnect memory (e.g., of host memory). The memory of each GVMI has different sections that are common to each GVMI. Before running the software, the VM global context needs to be considered by the processing unit, and the GVMI region for the code, data and stack etc. needs to be determined and that affects the wakeup process. There are also environments where the granularity of the GVMI sections is finer, such as per process (each GVMI may have multiple processes). For example, a GMVI may include a region for code of one process and another region for code of another process. Also, there may be different watchdog mechanisms to protect from starvation and hogging of resources and there may be exceptions in case an event occurs. The watchdog mechanisms may be packet specific and affect the wakeup process.

In some processors and environments, the above wakeup process is not material, but in restrictive environments (e.g., for a processing unit which is highly integrated with packet processing, where the processing cores are limited in area, power, and processing abilities), the wakeup delay may be material especially where the wakeup delay is per network flow, and packet processing may need to maintain high processing rates, e.g., of 200 million packets per second. In such environments, the wakeup time should be in the order of hundreds of nanoseconds to sub-microseconds to maintain the desired packet processing rates.

Embodiments of the present invention solve at least some of the above drawbacks by accelerating software activation (e.g., wakeup) in packet processing hardware by performing at least some of the activation tasks in the packet processing hardware such as scheduling and memory setup tasks.

Accelerating activation in hardware is particularly effective when: the software program has a predetermined runtime thereby allowing for simplified scheduling; and memory locations and virtual address space are well defined (e.g., memory regions for program code, stack regions, user data regions (e.g., for packets, headers, packet metadata, and other states)) thereby allowing simplified memory setup. The processor unit may run different software programs having respective memory locations and virtual address spaces that are well defined (e.g., memory regions for program code, stack regions, user data regions (e.g., for packets, headers, packet metadata, states)) thereby allowing simplified memory setup for the different software programs called by the packet processing hardware.

In some embodiments, when a packet is processed in the packet processing hardware, the steering function compares part(s) of the packet header and/or packet metadata (e.g., data about the packet being processed generated during packet processing) to one or more match and action tables. The match and action tables provide suitable actions to be performed on packets or their metadata. For a given packet, a matched action may specify that a given software program should be executed by a processing unit based on given data (e.g., packet header or packet metadata). The actions may be encoded to keep the data included in the actions as compact as possible. The matched action may indicate details about execution of the given software program. The details about the given software program may include any one or more of the following: a program identifier (e.g., to a program counter or the program counter itself) of the given software program; control parameters (e.g., regarding privileges) for use in executing the given software program; address space information (e.g., pointing to the packet, the packet header, packet metadata, states, etc. in memory), for use in executing the given software program; and a stack identifier of a stack region for use in executing the given software program.

In some embodiments, activation context builder hardware in the packet processing hardware translates at least some of the data in the matched action to instructions readable by the processing unit and optionally for other hardware of the packet processing hardware, such as memory setup hardware and scheduler hardware, described below.

As the form of the address space used by the different software programs is known, in some embodiments, the memory setup hardware performs memory setup tasks as part of the software activation. The memory setup tasks may include configuring a translation lookaside buffer (TLB) based on the address space information indicated in the action and configuring memory access permissions based on control parameters and address space information indicated in the action. The TLB is responsible for translating virtual to physical addresses and provides protection when accessing virtual memory.

Scheduling may be simplified when the software program has a predetermined runtime and control returns to the packet processing hardware at the completion of execution. The scheduling hardware tracks use of the processing unit (e.g., by processing core) and finds free threads on which to run software programs called by packet processing hardware. The scheduling hardware may also maintain a list of pending software program execution requests. The scheduling hardware provides the activation data to the processing unit, selects an interrupt type, and generates an interrupt to the processing unit (e.g., to a given processing core) based on finding a free hardware thread on which to execute the given software program.

The activation data provided to the processing unit may include any one or more of the following: a program identifier of the given software program; a stack identifier of a stack region for use in executing the given software program; address space information for use in executing the given software program (e.g., an internal state of the hardware processing hardware associated with the packet, metadata accumulated in prior stages of packet processing, a state shared with a host device, a map of a state that is internal to the given software program that is going to be executed); control parameters for use in executing the given software program; and a pointer to data of at least part of the packet (e.g., packet header or metadata) being processed by the packet processing hardware.

On detecting the interrupt signal, the processing unit executes the given software program based on the activation task already performed in the packet processing hardware. In particular, the given software program starts execution with a mapped address memory space and can load and/or store the different memory regions in the mapped address memory space (e.g., including an internal state of the hardware processing hardware associated with the packet, metadata accumulated in prior stages of packet processing, a state shared with a host device, a map of a state that is internal to the given software program that is going to be executed).

Once the execution of the software program has completed, the processing unit returns control to the packet processing software to continue processing of the packet. In some embodiments, the given software program or different software programs may be called more than once by the packet processing hardware to perform software processing tasks. The accelerated activation in hardware may reduce activation time significantly, and in some examples the activation may require no memory accesses and a small number (e.g., 10s of) instructions.

The processing unit may also execute the software program(s) without an underlying kernel while still providing the benefits of isolation, protection, and virtual memory. In some embodiments, a kernel may be used (e.g., where multiple processes are running per GVMI or per process environment) to provide isolation by GVMI or process environment. In certain implementations a kernel may be needed to provide isolation.

### System Description

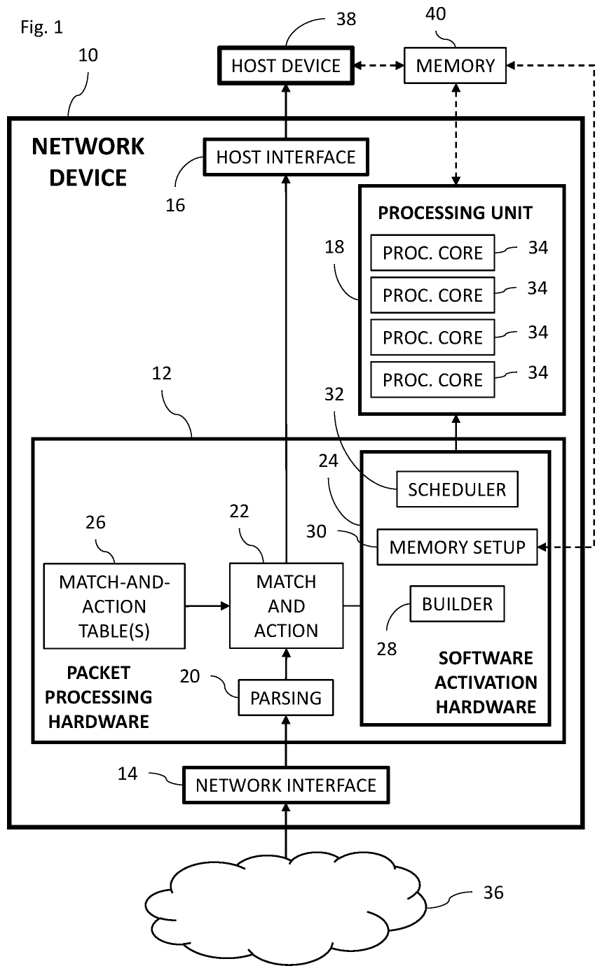

Reference is now made to FIG. 1, which is a block diagram view of a network device 10 constructed and operative in accordance with an embodiment of the present invention. Network device 10 includes packet processing hardware 12, a network interface 14, a host interface 16, and a processing unit 18. Network interface 14 is configured to receive packets from a network 36 and send packets over network 36. The host interface 16 is configured to send at least some of the received packets to a host device 38 and receive packets from the host device 38, e.g., for sending over the network 36. The network device 10 and/or the host device 38 may store data to, and/or retrieve data from, a shared memory 40. Memory 40 may be used to store packets, metadata about the packets, and other data, for example, software code executed by the processing unit 18 and states of the packet processing hardware 12. The processing unit 18 may include any suitable processor (e.g., RISC-V) configured to execute software programs. The processing unit 18 may include one or multiple processing cores 34.

Packet processing hardware 12 may include a physical layer (PHY) unit (not shown), a MAC unit (not shown) and other packet processing elements (not shown). Packet processing hardware 12 may be implemented as an ASIC or, alternatively, implemented using multiple physical components. The packet processing hardware 12 also includes parsing circuitry 20, match and action circuitry 22, and software activation hardware 24. Parsing circuitry 20 is configured to parse headers of packets into sections. The match and action circuitry 22 is configured to match sections of the headers or other packet data or metadata to keys in match-and-action tables 26 to determine how to further process the packet. The actions may include forwarding, dropping, amending a header, encapsulation, decapsulation, rewrite, smooth, switch, or sort, for example. The actions may include calling software application(s) to execute on processing unit 18.

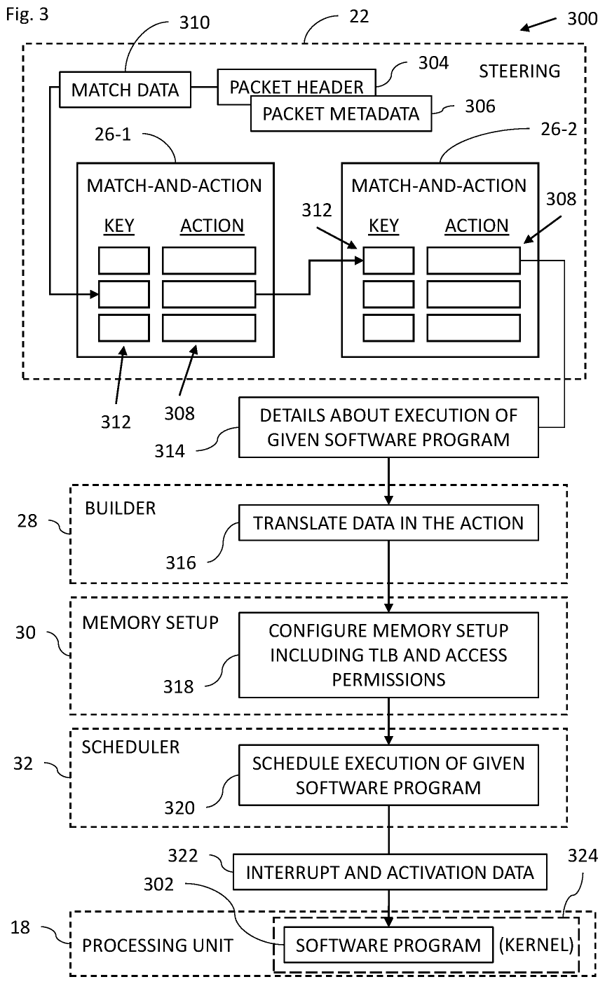

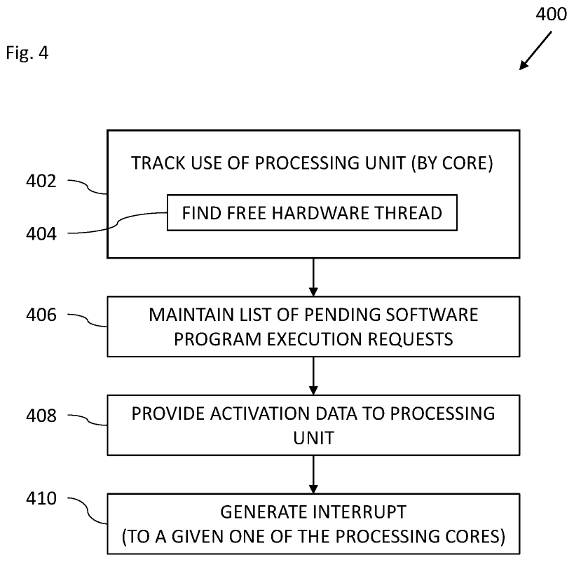

Software activation hardware 24 includes elements to accelerate activation of software programs in hardware. The software activation hardware 24 includes activation context builder hardware 28, memory setup hardware 30, and scheduler hardware 32. The software activation hardware 24 is described in more detail with reference to FIGS. 3 and 4.

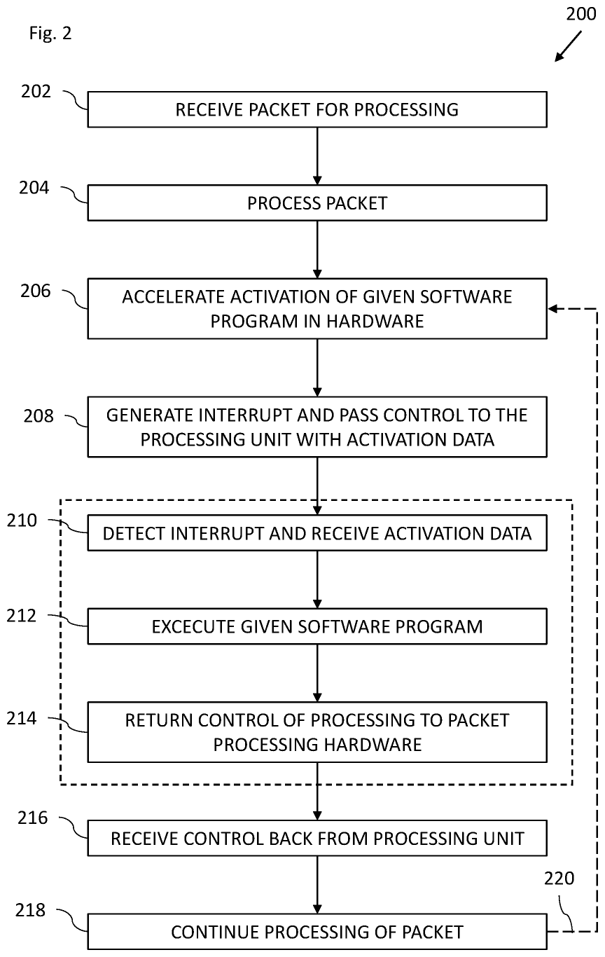

Reference is now made to FIG. 2, which is a flowchart 200 including steps in a method of processing a packet in the network device 10 of FIG. 1. The packet processing hardware 12 is configured to receive a packet for processing (block 202) and process the packet (block 204). The software activation hardware 24 of the packet processing hardware 12 is configured to accelerate activation of a given software program by performing one or more activation tasks of the given software program in hardware (block 206) and generate an interrupt to request the processing unit 18 (e.g., a given processing core 34 of the processing unit 18) to execute the given software program to perform processing associated with the packet (block 208). The steps of blocks 206 and 208 are described in more detail with reference to FIGS. 3 and 4.

The processing unit 18 (e.g., the given processing core 34 of the processing unit 18) is configured to detect the interrupt signal and receive/retrieve activation data from the software activation hardware 24 (block 210). The processing unit 18 (e.g., the given processing core 34 of the processing unit 18) is configured to execute the given software program and perform processing associated with the packet, responsively to the activation task(s) (e.g., activation data) performed by the software activation hardware 24 of the packet processing hardware 12 (block 212). The given software program may have a predetermined runtime. The processing unit 18 (e.g., the given processing core 34 of the processing unit 18) is configured to execute the given software program until completion of the given software program and return control of processing the packet to the packet processing hardware (block 214). The given software program may process data of the packet header or metadata of the packet, for example.

The software activation hardware 24 of the packet processing hardware 12 is configured to receive control back from the processing unit 18 (block 216) and signal the packet processing hardware 12, which is configured to continue processing the packet responsively to the completion of the execution of the given software program (block 218).

In some embodiments, the packet processing hardware 12 is configured to invoke the processing unit successively (one-after the other, with or without processing gaps) multiple times (arrow 220) for the same packet to execute at least one software program to perform processing associated with the packet (blocks 206-208). The same software program may be invoked each time or different software programs may be invoked. Therefore, processing unit 18 is configured to successively execute the software program(s) and perform processing associated with the same packet (blocks 210-214).

Reference is now made to FIG. 3, which is a block diagram 300 showing hardware activation of a software program 302 in the network device 10 of FIG. 1. When a packet is processed in the packet processing hardware 12, the match and action circuitry 22 of the packet processing hardware 12 matches (block 310) data associated with the packet (e.g., a packet header 304 and/or packet metadata 306—e.g., data about the packet being processed and generated during packet processing) to one or more match-and-action tables 26. Match-and-action tables 26 provide suitable actions 308 to be performed on packets or their metadata. The data associated with the packet, or a hash thereof, may be matched to a key 312 of one of the match-and-action tables 26-1 to yield a corresponding action 308. The action 308 may indicate another match-and-action table 26-2 on which to match data of the packet to a key of that match-and-action table 26-2, or may indicate a process that should be performed. The same may occur with the second table (i.e., that the action refers to another match-and-action table 26), and so on.

For a given packet, a matched action may specify that a given software program should be executed by the processing unit 18 based on given data (e.g., packet header 304 or packet metadata 306). The actions may be encoded to keep the data included in the actions as compact as possible. The matched action may indicate details 314 about execution of the given software program. The details about the given software program include any one or more of the following: a program identifier (e.g., to a program counter or the program counter itself) of the given software program; control parameters (e.g., regarding privileges) for use in executing the given software program (as the program runtime is predetermined); address space information (e.g., pointing to the packet, the packet header, packet metadata, states, etc. in memory), for use in executing the given software program; and a stack identifier of a stack region for use in executing the given software program. The address space information may indicate a global virtual machine identifier (GVMI) region of the given software program. The GVMI region may be shared by multiple software programs and the GVMI region is sub-divided among the software programs.

As previously mentioned, the details 314 included in the actions may be encoded to keep the data included in the actions as compact as possible. Therefore, activation context builder hardware 28 is configured to translate at least some of the data of the details 314 in the matched action to data readable by the processing unit 18 (block 316) and optionally for other hardware of the packet processing hardware 12, such as the memory setup hardware 30 and the scheduler hardware 32.

As the form of the address space used by the different software programs is known, and runtime of the given software program 302 is predetermined, in some embodiments, the memory setup hardware 30 performs memory setup tasks as part of the software activation. The memory setup hardware 30 is configured to configure a translation lookaside buffer (TLB) based on address space information indicated in the matched action (block 318). The TLB is responsible for translating virtual to physical addresses and provides protection when accessing virtual memory. The memory setup hardware 30 may also be configured to configure memory access permissions based on control parameters and address space information indicated in the matched action (block 318).

The scheduler hardware 32 is configured to schedule execution of the given software program 302 (block 320). The scheduler hardware 32 is configured to provide activation data to the processing unit 18 and generates an interrupt signal for detection by the processing unit 18 (block 322). The scheduler hardware 32 is described in more detail with reference to FIG. 4.

In some embodiments, the processing unit 18 is configured to execute the given software program 302 without an underlying kernel. In some embodiments, the processing unit 18 is configured to execute a kernel 324 on which to execute the given software program 302.

Reference is now made to FIG. 4, which is a flowchart 400 including steps in a method of operation of scheduler hardware 32 in the network device 10 of FIG. 1. Scheduling may be simplified when the software program has a predetermined runtime and control returns to the scheduler hardware 32 of the packet processing hardware 12 at the completion of execution. The scheduler hardware 32 is configured to track use of the processing unit 18 (block 402). In some embodiments, the scheduler hardware 32 is configured to track use of the processing cores 34. As part of the tracking, the scheduler hardware 32 is configured to find a free hardware thread of the processing unit 12 (e.g., in one of the processing cores 34) on which to run the software program 302 (block 404). The scheduler hardware 32 is configured to maintain a list of pending software program execution requests (block 406). The scheduler hardware 32 is configured to provide activation data (e.g., the data itself and/or a link or links to the data) for the given software program 302 to the processing unit 302 (block 408).

The activation data provided to the processing unit 300 may include any one or more of the following: a program identifier of the given software program 302; a stack identifier of a stack region for use in executing the given software program 302; address space information for use in executing the given software program 302 (e.g., an internal state of the hardware processing hardware associated with the packet being processed, metadata accumulated in prior stages of packet processing, a state shared with the host device 38, a map of a state that is internal to the given software program 302 that is going to be executed); control parameters for use in executing the given software program 302; and a pointer to data of at least part of the packet (e.g., packet header 304 or metadata 306) being processed by the packet processing hardware 12.

In response to finding a free hardware thread, the scheduler hardware 32 is configured to select an interrupt type and generate an interrupt signal to request the processing unit 18 (or a given one of the processing cores 34 having the found free hardware thread) to execute the given software program 302 on the found free hardware thread based on the activation data provided by the scheduler hardware 32 to the processing unit 18 (block 410).

On detecting the interrupt signal, the processing unit 18 executes the given software program 302 based on the activation task(s) already performed in the packet processing hardware 12. In particular, the given software program 302 starts execution with a mapped address memory space and can load and/or store the different memory regions in the mapped address memory space (e.g., including an internal state of the hardware processing hardware associated with the packet, metadata accumulated in prior stages of packet processing, a state shared with a host device, a map of a state that is internal to the given software program that is going to be executed).

In practice, some or all of the functions of the processing unit 18 may be combined in a single physical component or, alternatively, implemented using multiple physical components. These physical components may comprise hard-wired or programmable devices, or a combination of the two. In some embodiments, at least some of the functions of the processing unit 18 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

Various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination.

The embodiments described above are cited by way of example, and the present invention is not limited by what has been particularly shown and described hereinabove. Rather the scope of the invention includes both combinations and sub-combinations of the various features described hereinabove, as well as variations and modifications thereof which would occur to persons skilled in the art upon reading the foregoing description and which are not disclosed in the prior art.

What is claimed is:

1. A network device, comprising:
a network interface to receive first packets from a network and send second packets over the network; and
packet processing hardware to:
process a packet;
accelerate activation of a given software program by performing at least one activation task of the given software program in hardware; and
generate an interrupt to request a processing unit to execute the given software program to perform processing associated with the packet; and
the processing unit to execute the given software program and perform processing associated with the packet, responsively to the at least one activation task performed by the packet processing hardware.

2. The device according to claim 1, wherein:
the given software program has a predetermined runtime;
the processing unit is to execute the given software program until completion of the given software program and return control of processing the packet to the packet processing hardware; and
the packet processing hardware is to continue processing the packet responsively to the completion of the execution of the given software program.

3. The device according to claim 1, wherein:
the packet processing hardware is to match data associated with the packet to an action responsively to at least one match-and-action table; and
the action indicates details about execution of the given software program.

4. The device according to claim 3, wherein the details about the given software program include any one or more of the following: a program identifier of the given software program; control parameters for use in executing the given software program; address space information for use in executing the given software program; and a stack identifier of a stack region for use in executing the given software program.

5. The device according to claim 4, wherein the address space information indicates a global virtual machine identifier (GVMI) region of the given software program.

6. The device according to claim 5, wherein GVMI region is shared by multiple software programs and the GVMI region is sub-divided among the software programs.

7. The device according to claim 3, wherein the packet processing hardware includes activation context builder hardware to translate data in the action to data readable by the processing unit.

8. The device according to claim 3, wherein the packet processing hardware includes memory setup hardware to configure a translation lookaside buffer (TLB) based on address space information indicated in the action.

9. The device according to claim 3, wherein the packet processing hardware includes memory setup hardware to configure memory access permissions based on control parameters and address space information indicated in the action.

10. The device according to claim 3, wherein the packet processing hardware includes scheduler hardware to:
track use of the processing unit including finding a free hardware thread of the processing unit;
maintain a list of pending software program execution requests;
provide activation data for the given software program to the processing unit; and
generate the interrupt to request the processing unit to execute the given software program on the free hardware thread based on activation data provided by the scheduler hardware to the processing unit.

11. The device according to claim 10, wherein the activation data includes any one or more of the following: a program identifier of the given software program; a stack identifier of a stack region for use in executing the given software program; address space information for use in executing the given software program; control parameters for use in executing the given software program; and a pointer to data of at least part of the packet being processed by the packet processing hardware.

12. The device according to claim 10, wherein:
the processing unit comprises multiple processing cores; and
the scheduler hardware is to:
track use of the processing cores; and
generate the interrupt to a given one of the processing cores having the free hardware thread.

13. The device according to claim 1, wherein the packet processing hardware includes memory setup hardware to configure a translation lookaside buffer (TLB) based on address space information of the given software program.

14. The device according to claim 1, wherein the packet processing hardware includes memory setup hardware to configure memory access permissions based on control parameters and address space information of the given software program.

15. The device according to claim 1, wherein the packet processing hardware includes scheduler hardware to:
track use of the processing unit including finding a free hardware thread of the processing unit;
maintain a list of pending software program execution requests;
provide activation data for the given software program to the processing unit; and
generate the interrupt to request the processing unit to execute the given software program on the free hardware thread based on activation data provided by the scheduler hardware to the processing unit.

16. The device according to claim 15, wherein the activation data includes any one or more of the following: a program identifier of the given software program; a stack identifier of a stack region for use in executing the given software program; address space information for use in executing the given software program; control parameters for use in executing the given software program; and a pointer to data of at least part of the packet being processed by the packet processing hardware.

17. The device according to claim 15, wherein:
the processing unit comprises multiple processing cores; and
the scheduler hardware is to:
track use of the processing cores; and
generate the interrupt to a given one of the processing cores having the free hardware thread.

18. The device according to claim 1, wherein:
the packet processing hardware is to invoke the processing unit successively multiple times for the packet to execute at least one software program to perform processing associated with the packet; and
the processing unit is to successively execute the at least one software program and perform processing associated with the packet.

19. The device according to claim 1, wherein processing unit is to execute a kernel on which to execute the given software program.

20. The device according to claim 1, wherein processing unit is to execute the given software program without an underlying kernel.

21. A networking method, comprising:
receiving first packets from a network and sending second packets over the network;
processing a packet;
accelerating activation of a given software program by performing at least one activation task of the given software program in hardware; and
generating an interrupt to request a processing unit to execute the given software program to perform processing associated with the packet; and
executing the given software program and perform processing associated with the packet, responsively to the at least one activation task.
